(19) United States
(12) Patent Application Publication
(10) Pub. No.: US 2005/0134542 A1
(43) Pub. Date: Jun. 23, 2005

(54) Liquid crystal driving circuit

(76) Inventor: Jun Iitsuka, Otsu-shi (JP)

Correspondence Address: MCDERMOTT WILL & EMERY LLP, 600 13TH STREET, N.W., WASHINGTON, DC, 20005-3096, US

(21) Appl. No.: 11/000,526

(22) Filed: Dec. 1, 2004

(30) Foreign Application Priority Data
Dec. 19, 2003 (JP) 2003-423802

(51) Int. Cl. G09G 3/36

(52) U.S. Cl. 345/98

(57) ABSTRACT

In the present liquid crystal driving circuit, a parasitic transistor formed in a digital-to-analog converting circuit is prevented from being switched on. The driving circuit comprises a digital-to-analog converting circuit that (i) includes MOS transistors corresponding to digits of an inputted digital signal, wherein gate electrodes of the MOS transistors are mutually connected with wirings made of the same material as the gate electrodes, and a parasitic transistor is formed between those MOS transistors, and (ii) selects, in response to the inputted digital signal, one of reference voltages as a result of switching operations of the MOS transistors, and outputs the selected voltage so as to be applied to an LCD element; and a regulator circuit that regulates a digital signal so that the amplitude is smaller than an amplitude of a signal which makes the parasitic transistor switch on and outputs the regulated digital signal as the inputted digital signal.

### BACKGROUND OF THE INVENTION

1. Field of the Invention

The present invention relates to a liquid crystal driving circuit that includes a D/A (digital-to-analog) converting circuit of a reference voltage selection type.

2. Description of the Related Art

The Unexamined Japanese Patent Application Publication No. 06-208337 discloses a D/A converting circuit of a reference voltage selection type.

The D/A converting circuit described in the above-identified disclosure is incorporated into a liquid crystal driving circuit for a liquid crystal display apparatus of the active matrix type. The D/A converting circuit selects one of a plurality of reference voltages according to an inputted digital image signal, and output the selected reference voltage as an analog image signal to be applied to a liquid crystal display element.

FIG. 4 is a schematic view of a circuit and illustrates an example of a layout for a conventional D/A converting circuit of a reference voltage selection type.

The D/A converting circuit 4000 is used for a liquid crystal display apparatus operable to display four levels of gray and includes six n-channel-type MOS transistors 400 to 405 so that one of four different reference voltages (Vref 1 to Vref4) is selected and outputted, according to a bit value of each digit of a two-bit digital signal (“DATA 0” and “DATA 1”).

For instance, when the bit value of DATA 0 is “0” and the bit value of DATA 1 is “1”, the n-channel-type MOS transistors 400, 401, and 405 are switched off, and the n-channel-type MOS transistors 402, 403, and 404 are switched on. Thus, the voltage Vref 2 is selected and outputted.

The D/A converting circuit 4000 is arranged so that the n-channel-type MOS transistors included in the circuit do not have parasitic transistors switched on, which may cause malfunction and damages of elements. More specifically, there are arrangements so that (i) the distance between the gate electrodes of adjacent n-channel-type MOS transistors is no smaller than L and (ii) the digital signal lines 406 to 409 connecting the gate electrodes of the n-channel-type MOS transistors are formed with, for example, a metal layer of aluminum, so as to be different from the polysilicon layer forming the gate electrodes 410 to 415.

As additional information, due to the recent trend that liquid crystal display apparatuses are designed to be able to display images with a larger number of levels of gray and with higher definition, the scale of a liquid crystal driving circuit included in each liquid crystal display apparatus has become larger, and the manufacturing cost thereof has increased. Accordingly, there is suggestion for simplifying the manufacturing steps of the circuit and reducing the manufacturing cost by reducing the scale of the D/A converting circuit with an arrangement of making the distance between gate electrodes of adjacent MOS transistors smaller than L and by forming the wiring between the gate electrodes of adjacent MOS transistors in the D/A converter with a polysilicon layer.

In such a case, however, there is the possibility that parasitic transistors formed between the MOS transistors included in the D/A converting circuit may be switched on, and the parasitic transistors may cause malfunction and damages of elements, as described above.

### SUMMARY OF THE INVENTION

The present invention aims to provide countermeasures for parasitic transistor being formed in such a D/A converting circuit. An object of the present invention is to provide a liquid crystal driving circuit with an arrangement that is able to prevent parasitic transistors formed in such a D/A converting circuit from being switched on.

In order to achieve the object, the present invention provides a liquid crystal driving circuit comprising: a converting circuit that (i) includes MOS transistors corresponding to an inputted signal, wherein gate electrodes of at least two of the MOS transistors are electrically connected with each other with a wiring made of a same material as the gate electrodes, and a parasitic transistor is formed between said at least two MOS transistors, and (ii) is operable to select one of a plurality of reference voltages as a result of switching operations of the MOS transistors, the selection being made in response to the inputted signal, and to output the selected reference voltage as a voltage to be applied to a liquid crystal display element; and a regulator circuit operable to regulate a signal so as to have a specific amplitude being smaller than an amplitude of a signal which makes the parasitic transistor change to an ON-state and to output the regulated signal having the specific amplitude as the inputted signal to the converting circuit.

With this arrangement, it is possible to prevent the parasitic transistors from being switched on because, in the liquid crystal driving circuit described above, the specific amplitude of the inputted signal is regulated so as to be smaller than an amplitude of the signal which makes the parasitic transistors in the converting circuit change to ON-states so that the regulated signal which doesn't make the parasitic transistors in the converting circuit switch on is outputted to the converting circuit as the inputted signal.

The liquid crystal driving circuit of the preferred embodiment may further have an arrangement wherein said at least two MOS transistors are positioned adjacent to each other and perform a switching operation concurrently with each other in response to a change of the inputted signal.

The liquid crystal driving circuit may further have an arrangement wherein the converting circuit includes a plurality of parasitic transistors, and the regulated signal has the specific amplitude being smaller than an amplitude of a signal which makes at least one of the parasitic transistors switch on.

Furthermore, the liquid crystal driving circuit may have an arrangement wherein the converting circuit includes: a first converting circuit including a plurality of n-channel-type transistors and being operable to output a first reference voltage in response to a first inputted signal; and a second converting circuit including a plurality of p-channel-type transistors and being operable to output a second reference voltage that is higher than the first reference voltage, in response to a second inputted signal, and the regulator circuit includes: a first regulator circuit operable to regulate a signal so as to have a first specific amplitude being smaller than an amplitude of a signal which makes a parasitic transistor formed in the first converting circuit switch on and to output the regulated signal as the first inputted signal; and a second regulator circuit operable to regulate a signal so as to have a second specific amplitude being smaller than an amplitude of a signal which makes a parasitic transistor formed in the second converting circuit switch on and to output the regulated signal as the second inputted signal.

The liquid crystal driving circuit may further have an arrangement wherein the regulator circuit further includes: a voltage generating circuit operable to generate a first voltage and a second voltage, and the first regulator circuit outputs the regulated signal having the first specific amplitude in response to a difference between the first voltage generated by the voltage generating circuit and a voltage of a first power supply, and the second regulator circuit outputs the regulated signal having the second specific amplitude in response to a difference between the second voltage generated by the voltage generating circuit and a voltage of a second power supply being different from the first power supply.

Furthermore, the liquid crystal driving circuit may have an arrangement wherein the regulator circuit includes: an amplitude determining circuit operable to output a voltage; a voltage follower coupled to the amplitude determining circuit and operable to stabilize the voltage; and an output buffer operable to output the regulated signal having the specific amplitude to the converting circuit in response to a difference between the stabilized voltage generated by the voltage follower and a voltage of a power supply.

Additionally, it is acceptable to have an arrangement wherein the amplitude determining circuit includes: a plurality of parasitic transistors for measurement; and a selecting circuit operable to apply voltages each having a different level from one another to gates of the plurality of parasitic transistors for measurement respectively and select one of the voltages in response to a switching operation of the plurality of parasitic transistors for measurement.

Here, the parasitic transistor for measurement is a transistor that simulates a parasitic transistor that may be formed on a source-drain path of MOS transistors included in a converting circuit.

According to the regulator circuit including the amplitude determining circuit with the above-mentioned arrangement, the signal outputted to the converting circuit has the voltage selected by the selecting circuit, i.e. the signal has a voltage that makes no parasitic transistors for measurement switch on. Consequently, the parasitic transistors in the converting circuit are not switched on.

The liquid crystal driving circuit may have an arrangement wherein the amplitude determining circuit includes: a parasitic transistor for measurement coupled to the power supply; and a current source coupled to another power supply being different from the power supply and a gate of the parasitic transistor for measurement, and a certain load is configured on a path between either a drain or a source of the parasitic transistor for measurement and the current source, the certain load being coupled to the gate and either the drain or the source of the parasitic transistor for measurement, and either the drain or the source of the parasitic transistor for measurement is coupled to an input terminal of the voltage follower, or wherein the amplitude determining circuit includes: a parasitic transistor for measurement coupled to the power supply; a current source coupled to another power supply being different from the power supply, to a gate, and to either a drain or a source of the parasitic transistor for measurement; a diode coupled to the gate, to either the drain or the source of the parasitic transistor for measurement, and to the current source; and a MOS transistor coupled to the diode, the MOS transistor constantly being kept in an ON-state, in such a manner that a connection node between the MOS transistor and the diode is coupled to an input terminal of the voltage follower, wherein an ON-state resistance of the MOS transistor is larger than an ON-state resistance of the parasitic transistor for measurement, or wherein the amplitude determining circuit includes: a plurality of MOS transistors for measurement whose source-drain paths being electrically connected in series, one end of the serially-connected plurality of MOS transistors for measurement being coupled to the power supply, gate electrodes of the plurality of MOS transistors for measurement being electrically connected with one another, each of the plurality of MOS transistors for measurement being equal in size to each of MOS transistors in the converting circuit respectively, a number of the plurality of MOS transistors for measurement being equal to or larger than a number of MOS transistors to select the selected reference voltage in the converting circuit; and a current source being configured between another end of the serially-connected plurality of MOS transistors for measurement and another power supply being different from the power supply, wherein a connection node of said another end of the serially-connected plurality of MOS transistors for measurement and the current source is connected to an input terminal of the voltage follower.

Moreover, the liquid crystal driving circuit may further have an arrangement wherein the regulator circuit further includes: a switch circuit operable to selectively switch between (i) a first connection provided between the voltage follower and the output buffer and (ii) a second connection provided between a first power supply and the output buffer; and a comparator circuit operable to compare a voltage of a second power supply with the selected reference voltage and, according to a result of the comparison, instruct the switching circuit to switch connections so as to have one of the first and second connections, wherein a supply of electric power to the voltage follower is stopped in a case where the switching circuit switches the connections so as to have the second connection.

With this arrangement, it is possible to save electric power because in a case where the voltage of either the power supply or said another power supply is lower than the selected reference voltage, the supply of electric power to the regulator circuit is stopped.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a functional block diagram for a liquid crystal display apparatus of the active matrix type;

FIG. 2 shows the configuration of the D/A converting circuit (Low) 121;

FIG. 3 shows the configuration of the D/A converting circuit (High) 120;

FIG. 4 is a schematic view of a circuit and illustrates an example of a layout for a conventional D/A converting circuit of a reference voltage selection type;

FIG. 5 is a schematic view of a circuit and illustrates an example of a layout for the D/A converting circuit of a reference voltage selection type according to an embodiment;

FIG. 6 shows the configurations of the regulator circuits 118 and 119;

FIG. 7 shows the configuration of the amplitude determining circuit 700;

FIG. 8 shows the configuration of the amplitude determining circuit 604A according to the first configuration example;

FIG. 9 shows the configuration of the amplitude determining circuit 606A according to the first configuration example;

FIG. 10 shows the configuration of the amplitude determining circuit 604B according to the second configuration example;

FIG. 11 shows the configuration of the amplitude determining circuit 606B according to the second configuration example;

FIG. 12 shows the configuration of the amplitude determining circuit 604C according to the third configuration example;

FIG. 13 shows the configuration of the amplitude determining circuit 606C according to the third configuration example;

FIG. 14 shows the configuration of the amplitude determining circuit 604D according to the fourth configuration example;

FIG. 15 shows the configuration of the amplitude determining circuit 606D according to the fourth configuration example;

FIG. 16 shows the configurations of the regulator circuits 118A and 119A in which the comparators 1600 and 1601 as well as the switches 1608 and 1609 are provided; and

FIG. 17 is a schematic view of in a cross section that illustrates the configuration of a parasitic transistor for measurement.

### DESCRIPTION OF THE PREFERRED EMBODIMENTS

The following describes an embodiment of a liquid crystal driving circuit of the present invention, with reference to the drawings.

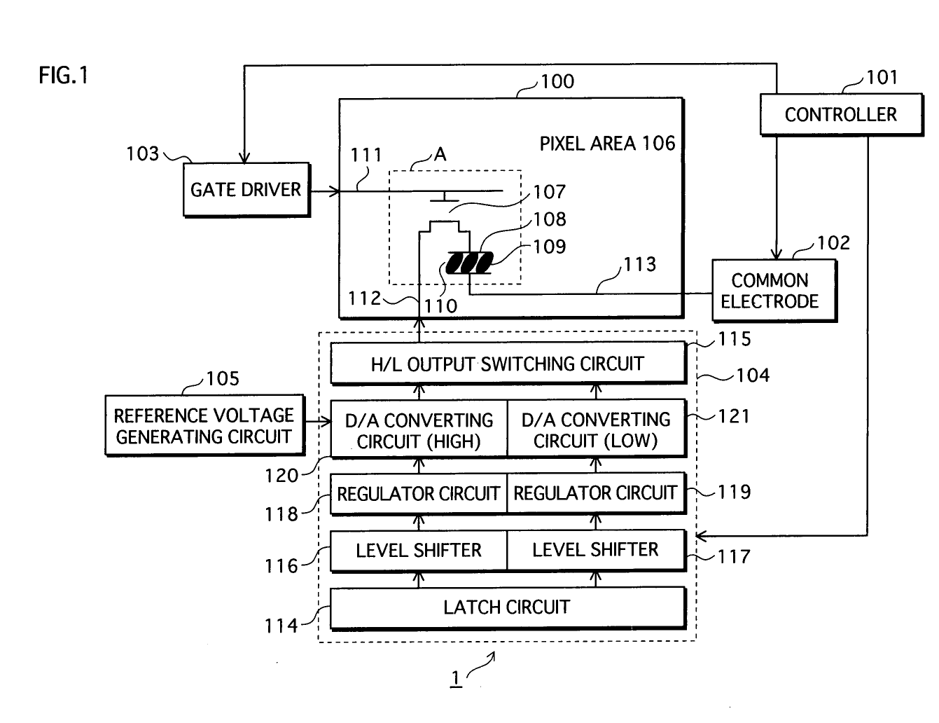

FIG. 1 is a functional block diagram for a liquid crystal display apparatus of the active matrix type.

The liquid crystal display apparatus 1 shown in the drawing comprises: a liquid crystal display unit 100, a controller 101, a common electrode 102, a gate driver 103, a source driver 104, which is the liquid crystal driving circuit of the present invention, and a reference voltage generating circuit 105.

In order to prevent degradation of liquid crystal layers, the liquid crystal display apparatus 1 performs what is called “alternating current reverse drive”, which is to reverse the polarity of the reference voltage to be transmitted to a liquid crystal display element in a certain cycle, such as a frame cycle or a line cycle.

The liquid crystal display unit 100 has a pixel area 106 according to the TFT method. The pixel area 106 includes a plurality of liquid crystal display elements. FIG. 1 shows only one liquid crystal display element among them.

The liquid crystal display element A includes: a TFT 107 operable to switch on and off the voltage applied to the liquid crystal display element A; a pixel electrode 108; a liquid crystal 109; and a pixel capacity 110.

The liquid crystal display element A is electrically connected with the gate driver 103 via the gate signal line 111, is electrically connected with the source driver 104 via the source signal line 112, and is electrically connected with the common electrode 102 via the common electrode line 113.

The liquid crystal 109 changes the light transmittance ratio with accumulation of an electric charge supplied to the pixel capacity 110 via the source signal line 112, the pixel capacity 110 being positioned between the common electrode 102 and the pixel electrode 108.

The controller 101 transmits a control signal, such as a digital image signal or a vertical synchronizing signal, to the source driver 104 and transmits a control signal, such as a horizontal synchronizing signal, to the gate driver 103.

The gate driver 103 outputs a scan signal to each liquid crystal display element via the gate signal line 111.

The source driver 104 includes, a latch circuit 114, an H/L output switching circuit 115, level shifters 116 and 117, regulator circuits 118 and 119, a D/A converting circuit (High) 120, and a D/A converting circuit (Low) 121.

The latch circuit 114 latches, in a time-division manner, the digital image signal transmitted from the controller 101.

Each of the level shifters 116 and 117 increases the voltage level of the digital image signal latched by the latch circuit 114 to a certain voltage level.

The regulator circuits 118 and 119 each regulate the amplitude of the digital image signal of which the level has been increased to the certain voltage level by the level shifter 116 and the level shifter 117, respectively, so that the amplitude is at such a level that no parasitic transistors formed in the D/A converting circuit (High) 120 and the D/A converting circuit (Low) 121 are switched on.

The D/A converting circuit (High) 120 and the D/A converting circuit (Low) 121 each take, as an input, the digital signal of the amplitude regulated by the regulator circuits 118 and 119 respectively, and select and output one of analog reference voltages that corresponds to the inputted digital image signal, out of a plurality of analog reference voltages generated by the reference voltage generating circuit 105 for the purpose of gray-scale display.

The H/L output switching circuit 115 takes, as inputs, the reference voltage (High) outputted by the D/A converting circuit (High) 120 and the reference voltage (Low) outputted by the D/A converting circuit (Low) 121, and switches alternately between the reference voltage (High) and the reference voltage (Low) in a certain cycle (e.g. a frame cycle) as a reference voltage to be outputted via the source signal line 112 to each liquid crystal display element in the pixel area 106.

Configuration of the D/A Converting Circuit

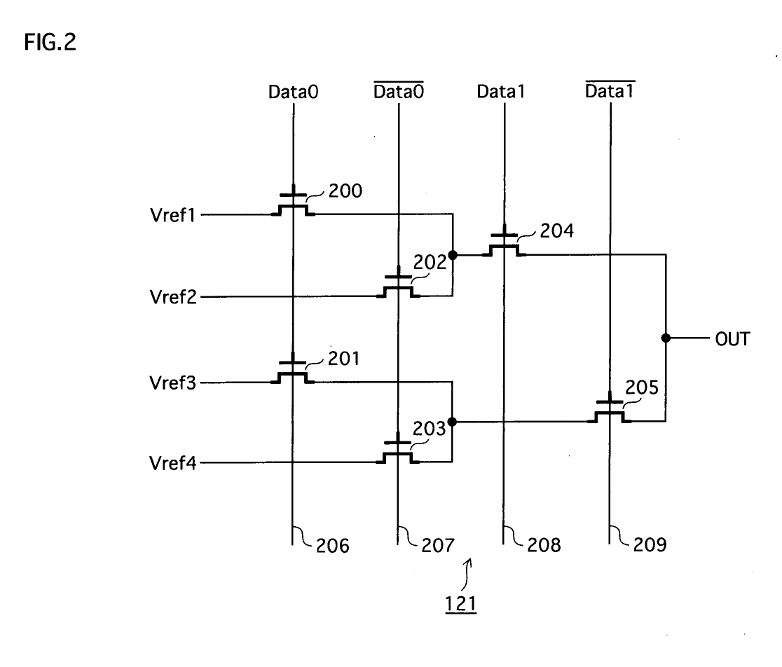

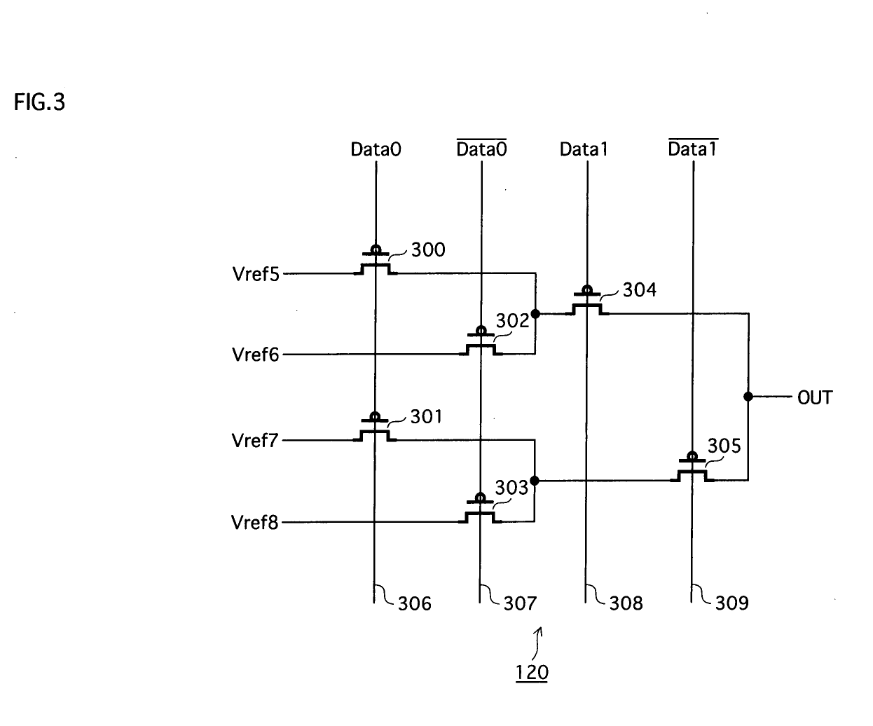

FIGS. 2 and 3 show the circuit configurations of the D/A converting circuit (High) 120 and the D/A converting circuit (Low) 121.

FIG. 2 shows the configuration of the D/A converting circuit (Low) 121.

The D/A converting circuit (Low) 121 includes n-channel-type MOS transistors 200 to 205 so that one of inputted four different reference voltages (Vref 1 to Vref 4) is selected and outputted, according to a bit value of each digit of a two-bit digital signal (“DATA 0” and “DATA 1”).

The D/A converting circuit (Low) 121 includes n-channel-type MOS transistors 200 to 205 that have a switching function. Each of the gate electrodes of the MOS transistors that are in correspondence with the digits of an inputted digital signal is electrically connected with one of the digital signal lines 206 to 209. As the MOS transistors function as switches, an analog reference voltage being one of Vref1 to Vref4 is outputted.

FIG. 3 shows the configuration of the D/A converting circuit (High) 120. The MOS transistors 300 to 305 having a switching function are p-channel-type MOS transistors. The gate electrodes of such MOS transistors that are in correspondence with a same digit of a digital signal are connected with one of the digital signal lines 306 to 309. As the MOS transistors function as switches, an analog reference voltage being one of Vref5 to Vref8 is outputted.

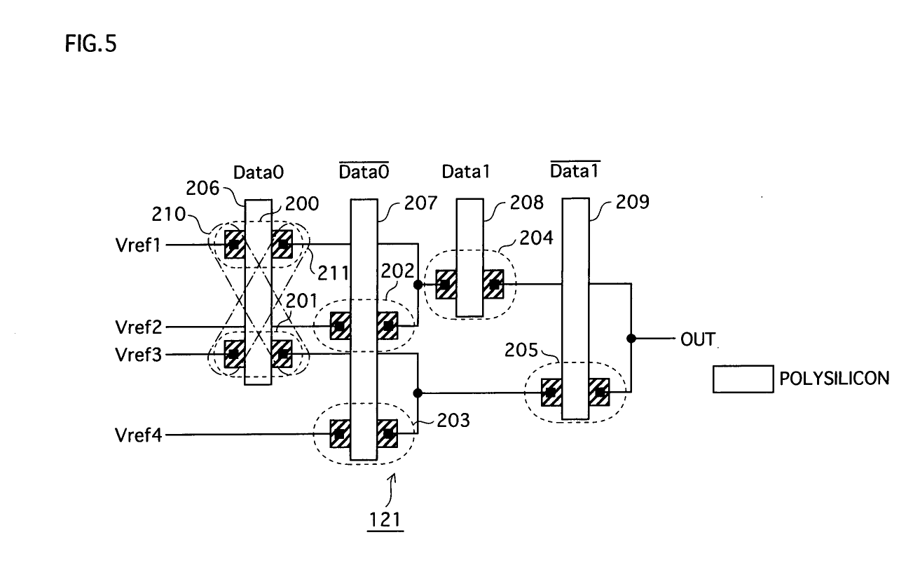

FIG. 5 is a schematic view of a circuit and illustrates an example of a layout for the D/A converting circuit (Low) 121. It should be noted that the layout of the D/A converting circuit (High) 120 is also similar to the one shown in FIG. 5.

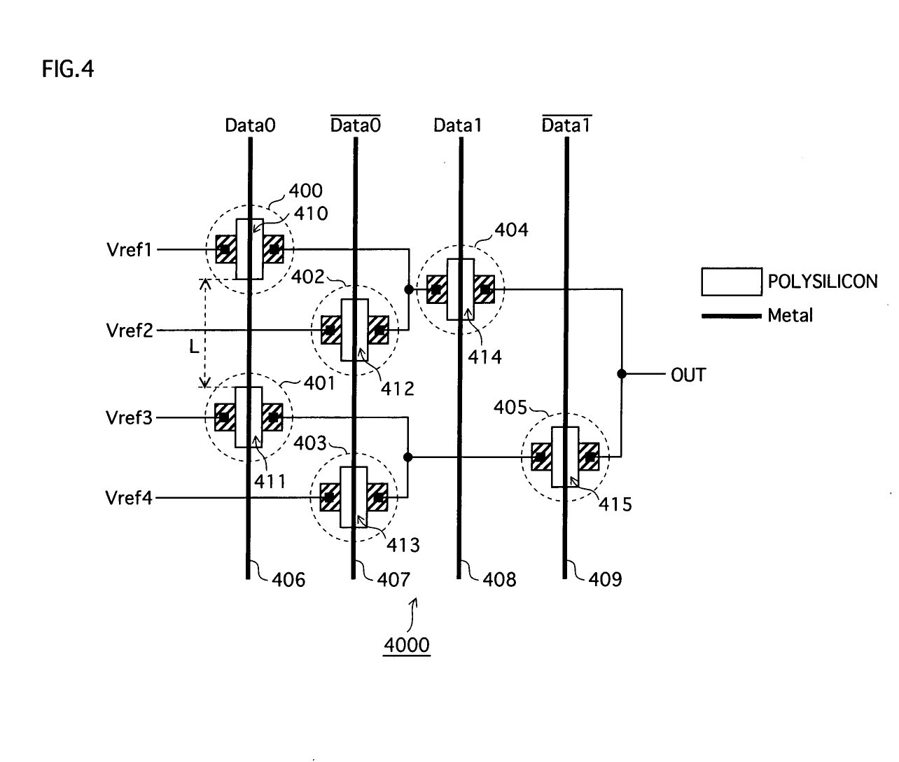

As shown in FIG. 5, the digital signal lines 206 to 209 are formed as polysilicon layers and each connect together the gate electrodes of adjacent MOS transistors that are in correspondence with a same digit of a digital signal inputted to the D/A converting circuit (Low) 121. Specifically, in the D/A converting circuit (Low) 121 having the layout shown in FIG. 5, it is not necessary to provide a metal layer that connects gate electrodes together, as used in the conventional D/A converting circuit 4000 shown in FIG. 4. Accordingly, it is possible to simplify the manufacturing steps of the circuit and reduce the manufacturing cost thereof, compared to the case of the D/A converting circuit 4000.

Further, as shown in FIG. 5, in the D/A converting circuit (Low) 121, the distance between adjacent MOS transistors is smaller than L. Consequently, the circuit area is smaller than that of the conventional D/A converting circuit 4000 shown in FIG. 4.

Although the D/A converting circuit (Low) 121 having the layout shown in FIG. 5 has an advantage that the manufacturing cost is reduced and the area size becomes smaller over the conventional D/A converting circuit 4000, the D/A converting circuit (Low) 121 also has a disadvantage that unnecessary parasitic transistors may be formed. The same is true with the D/A converting circuit (High) 120. For example, parasitic transistors 210 and 211 can be formed between the gate electrodes of the n-channel-type MOS transistors 200 and 201.

To cope with this problem, the source driver 104 includes the regulator circuits 118 and 119 that are each operable to regulate the amplitude of the digital signal to be inputted to the D/A converting circuit (High) 120 and the D/A converting circuit (Low) 121 in such a manner that no parasitic transistors formed in the D/A converting circuit (High) 120 and the D/A converting circuit (Low) 121 are switched on.

The Configurations of the Regulator Circuits

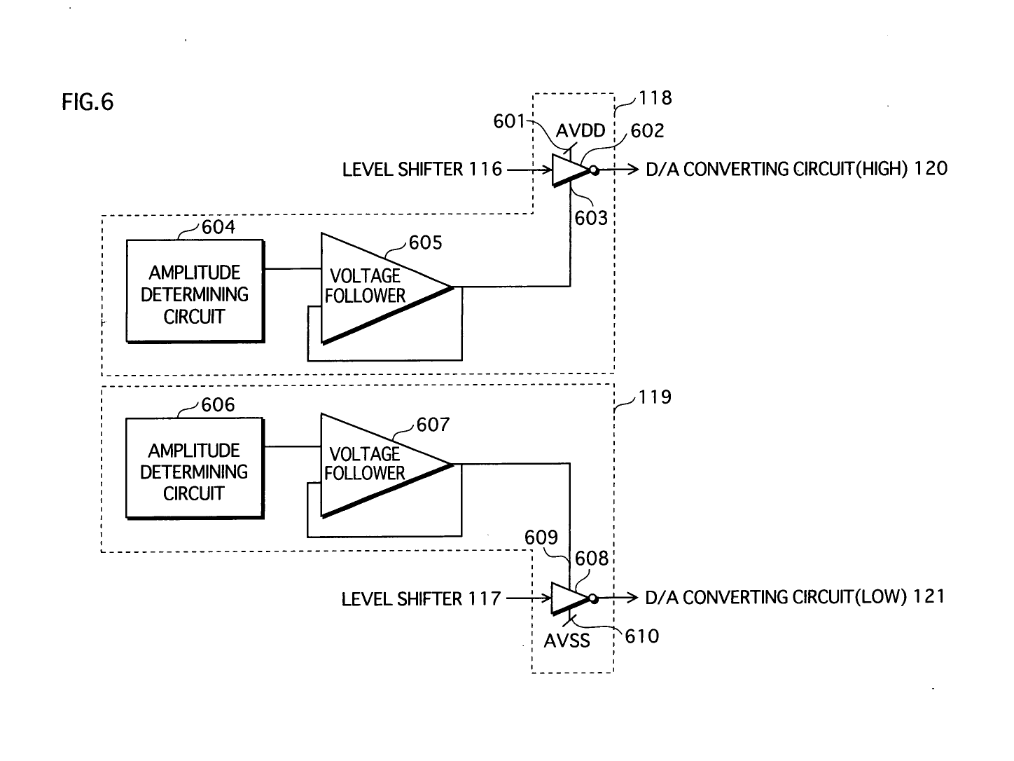

The following describes the configurations of the regulator circuits 118 and 119. FIG. 6 shows the functional configurations of the regulator circuits 118 and 119.

Firstly, explanation on the regulator circuit 118 will be provided. The regulator circuit 118 includes a buffer circuit 602, an amplitude determining circuit 604, and a voltage follower 605.

The amplitude determining circuit 604 determines an amplitude of a signal to be inputted as a negative power supply for the buffer circuit 602. The amplitude of the signal is determined to be at such a level that, when being applied to the gate electrode of a p-channel-type MOS transistor in the D/A converting circuit (High) 120, no parasitic transistors formed between the p-channel-type MOS transistors are switched on.

The buffer circuit 602 outputs, as a voltage at which the p-channel-type MOS transistors in the D/A converting circuit (High) 120 is switched into an ON-state, the voltage inputted from the negative power supply terminal 603 according to the digital signal inputted from the level shifter 116, and outputs, as a voltage to switch off the p-channel-type MOS transistors in the D/A converting circuit (High) 120, the voltage inputted from the positive power supply terminal 601.

To be more specific, a digital signal to be inputted to the D/A converting circuit (High) 120 has an amplitude whose maximum voltage is the voltage inputted from the positive power supply terminal 601 and whose minimum voltage is the voltage inputted from the negative power supply terminal 603.

In the above description, the voltage inputted from the positive power supply terminal of the buffer circuit 602 is a power supply voltage (hereafter referred to as “AVDD”).

The voltage follower 605 is a circuit that stably supplies a signal having the amplitude outputted from the amplitude determining circuit 604 to the buffer circuit 602.

Secondly, explanation on the regulator circuit 119 will be provided.

The regulator circuit 119 includes a buffer circuit 608, an amplitude determining circuit 606, and a voltage follower 607.

The amplitude determining circuit 606 determines an amplitude of a signal to be inputted as a positive power supply for the buffer circuit 608. The amplitude is determined to be at such a level that, when being applied to the gate electrode of an n-channel-type MOS transistor in the D/A converting circuit (Low) 121, no parasitic transistors formed between the n-channel-type MOS transistors are switched on.

The buffer circuit 608 outputs, as a voltage at which the n-channel-type MOS transistors in the D/A converting circuit (Low) 121 is switched into an ON-state, the voltage inputted from the positive power supply terminal 609 according to the digital signal inputted from the level shifter 117, and outputs, as a voltage to switch off the n-channel-type MOS transistors in the D/A converting circuit (Low) 121, the voltage inputted from the negative power supply terminal 610.

To be more specific, a digital signal to be inputted to the D/A converting circuit (Low) 121 has an amplitude whose maximum voltage is the voltage inputted from the positive power supply terminal 609 and whose minimum voltage is the voltage inputted from the negative power supply terminal 610.

In the above description, the voltage inputted from the negative power supply terminal of the buffer circuit 608 is a ground voltage (hereafter referred to as “AVSS”).

The voltage follower 607 is a circuit that stably supplies the certain voltage outputted from the amplitude determining circuit 606 to the buffer circuit 608.

It should be noted that the substrate potential of the p-channel-type MOS transistors included in the D/A converting circuit (High) 120 is maintained at AVDD. The substrate potential of the n-channel-type MOS transistors included in the D/A converting circuit (Low) 121 is maintained at AVSS.

The Configurations of the Amplitude Determining Circuits

The following describes the configurations of the amplitude determining circuit 604 and 606.

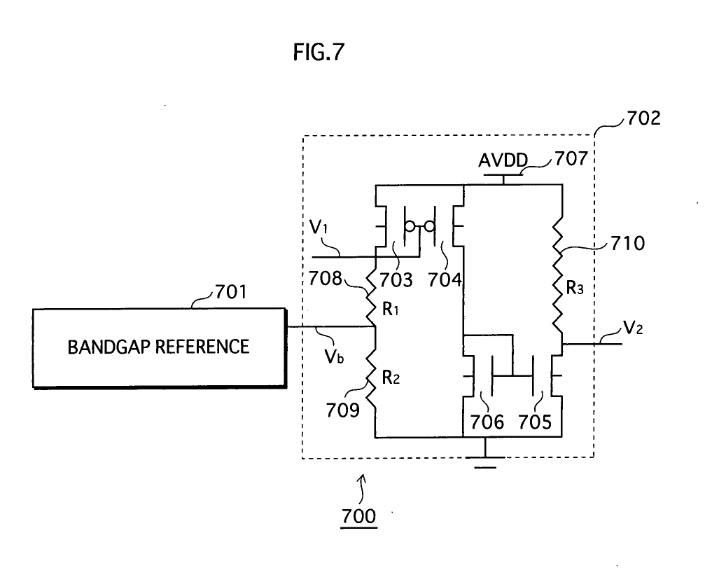

FIG. 7 shows the configuration of the amplitude determining circuit 700 that has the functions of both the amplitude determining circuit 604 and the amplitude determining circuit 606.

The amplitude determining circuit 700 includes a bandgap reference 701 operable to stably supply a voltage of a certain level and a current mirror circuit 702.

The current mirror circuit 702 includes: the p-channel-type MOS transistors 703 and 704; n-channel-type MOS transistors 705 and 706; the resistor 708 of which the resistance value is R1; the resistor 709 of which the resistance value is R2; the resistor 710 of which the resistance value is R3; and the power supply 707 that supplies AVDD.

Here, the output voltages V1 and V2 shown in FIG. 7 can be expressed in the following equations:
V1=((R1+R2)/R2)*Vb
V2=AVDD−(R3/R2)*Vb

It should be noted that Vb is an input voltage from the bandgap reference 701. The output voltage V1 is outputted to the D/A converting circuit (Low) 121. The output voltage V2 is outputted to the D/A converting circuit (High) 120.

With the use of the amplitude determining circuit 700, it is possible to obtain desired voltages V1 and V2 by adjusting the resistors 706 to 708, the inputted voltage Vb from the bandgap reference 701, and the voltage AVDD of the power supply 707.

For example, it would be desirable to calculate in advance, through simulations, such a level of amplitude that no parasitic transistors formed between the MOS transistors included in the D/A converting circuit (High) 120 and the D/A converting circuit (Low) 121 are switched on, so that the amplitude of the calculated level is outputted stably as V1 and V2.

Each of the following equations shows an example of amplitude of such a level at which no parasitic transistors formed between the MOS transistors included in the D/A converting circuit (High) 120 and the D/A converting circuit (Low) 121 are switched on:
V1=AVDD/2, and V2=AVDD/2.
Other Examples for Configurations of the Amplitude Determining Circuits

The configurations of the amplitude determining circuits 604 and 606 are not limited to the configuration of the amplitude determining circuit 700 shown in FIG. 7. The following describes the other configuration examples (the first through fourth examples) for the amplitude determining circuit 604 and 606.

The First Configuration Example

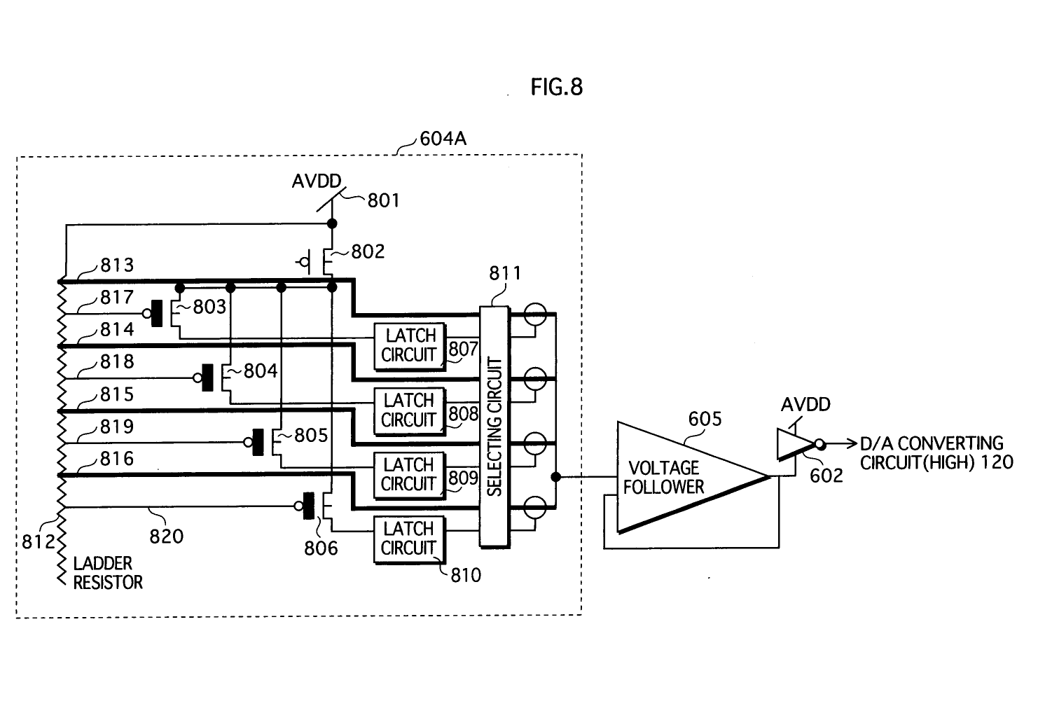

FIG. 8 shows the configuration of the amplitude determining circuit 604A according to the first configuration example.

The amplitude determining circuit 604A has another example of configuration that corresponds to the amplitude determining circuit 604 shown in FIG. 6.

The amplitude determining circuit 604A includes the power supply 801, the p-channel-type MOS transistor 802, the parasitic transistors for measurement 803 to 806, the latch circuits 807 to 810, the selecting circuit 811, the ladder resistor 812, and the wirings 813 to 820.

Each of the parasitic transistors for measurement 803 to 806 simulates, for the purpose of measurement, a parasitic transistor formed on a source-drain path of MOS transistors included in the D/A converting circuit (High) 120 and has the p-channel-type property.

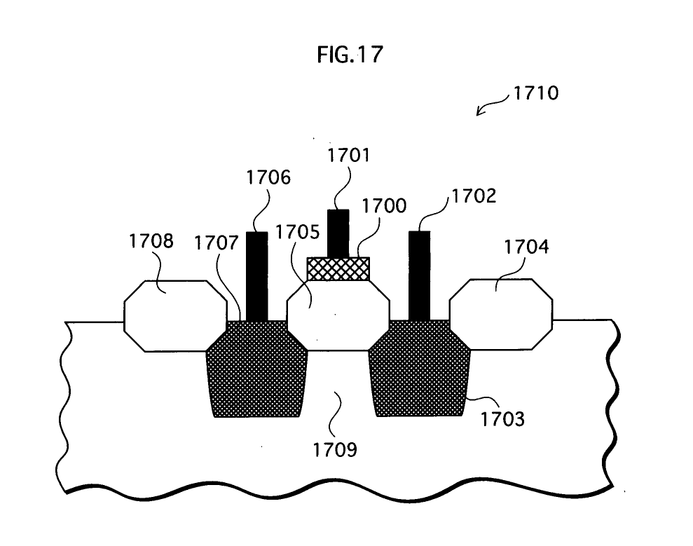

FIG. 17 is a schematic view in a cross section that illustrates the configuration of each of the parasitic transistors for measurement. As shown in the drawing, the parasitic transistor for measurement 1710 includes the source 1707, the source electrode 1706, the gate 1700, the gate electrode 1701, the drain 1703, the drain electrode 1702, the insulator films 1708, 1704, 1705, and the substrate 1709.

The thickness of the insulator film 1705 is arranged to be as thick as each of the insulator films 1704 and 1708 in the field area.

Mutually different voltages are applied to the gate electrodes of the parasitic transistors for measurement 803 to 806 respectively, and the latch circuits 807 to 810 memorize whether or not the parasitic transistors for measurement 803 to 806 each have been switched on.

For example, when the MOS switch 802 is switched into an ON-state with certain timing, and voltages of mutually different levels are applied to the parasitic transistors for measurement 803 to 806 via the wirings 817 to 820 respectively. In a case where the parasitic transistors for measurement 805 and 806 each come into an ON-state, the latched values will be as the following: “0” is latched to the latch circuit 807, “0” is latched to the latch circuit 808, “1” is latched to the latch circuit 809, and “1” is latched to the latch circuit 810.

According to the values latched by the latch circuits 807 to 810, the selecting circuit 811 selects, from among the voltages applied via the wirings 813 to 816, a voltage that is higher than the smallest voltage (i.e. the voltage applied to the wiring 818) at the level at which no parasitic transistors for measurement are switched on by the threshold value of the parasitic transistor for measurement 804 (in other words, the selecting circuit 811 selects the voltage applied to the wiring 814) and outputs the selected voltage to the voltage follower 605.

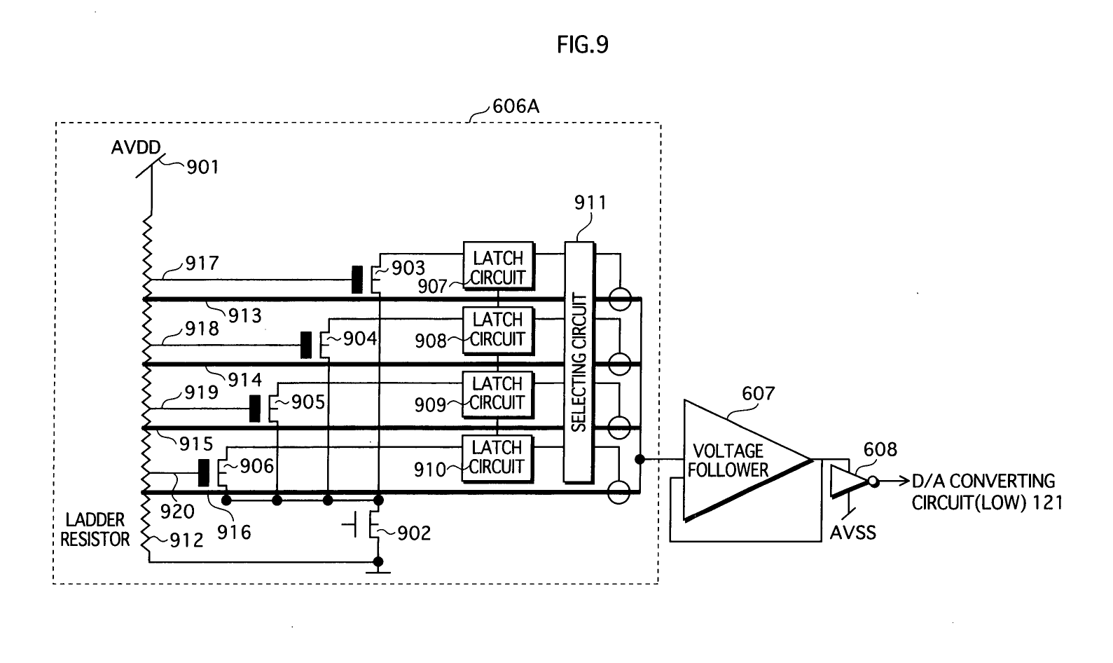

FIG. 9 shows the configuration of the amplitude determining circuit 606A according to the first configuration example.

The amplitude determining circuit 606A has another example of configuration that corresponds to the amplitude determining circuit 606 shown in FIG. 6.

The amplitude determining circuit 606A includes the power supply 901, the n-channel-type MOS transistor 902, the parasitic transistors for measurement 903 to 906, the latch circuits 907 to 910, and the selecting circuit 911, the ladder resistor 912, and the wirings 913 to 920.

Each of the parasitic transistors for measurement 903 to 906 simulates, for the purpose of measurement, a parasitic transistor formed on a source-drain path of MOS transistors included in the D/A converting circuit (Low) 121 and has the n-channel-type property.

Mutually different voltages are applied to the gate electrodes of the parasitic transistors for measurement 903 to 906 respectively, and the latch circuits 907 to 910 memorize whether or not the parasitic transistors for measurement 903 to 906 each have been switched on.

For example, when the MOS switch 902 is switched into an ON-state with certain timing, and voltages of mutually different levels are applied to the parasitic transistors for measurement 903 to 906 via the wirings 917 to 920 respectively. In a case where the parasitic transistors for measurement 903 and 904 each come into an ON-state, the latched values will be as the following: “1” is latched to the latch circuit 907, “1” is latched to the latch circuit 908, “0” is latched to the latch circuit 909, and “0” is latched to the latch circuit 910.

According to the values latched by the latch circuits 907 to 910, the selecting circuit 911 selects, from among the voltages applied via the wirings 913 to 916, a voltage that is lower than the largest voltage (i.e. the voltage applied to the wiring 919) at the level at which no parasitic transistors for measurement are switched on by the threshold value of the parasitic transistor for measurement 905 (in other words, the selecting circuit 911 selects the voltage applied to the wiring 915) and outputs the selected voltage to the voltage follower 607.

The Second Configuration Example

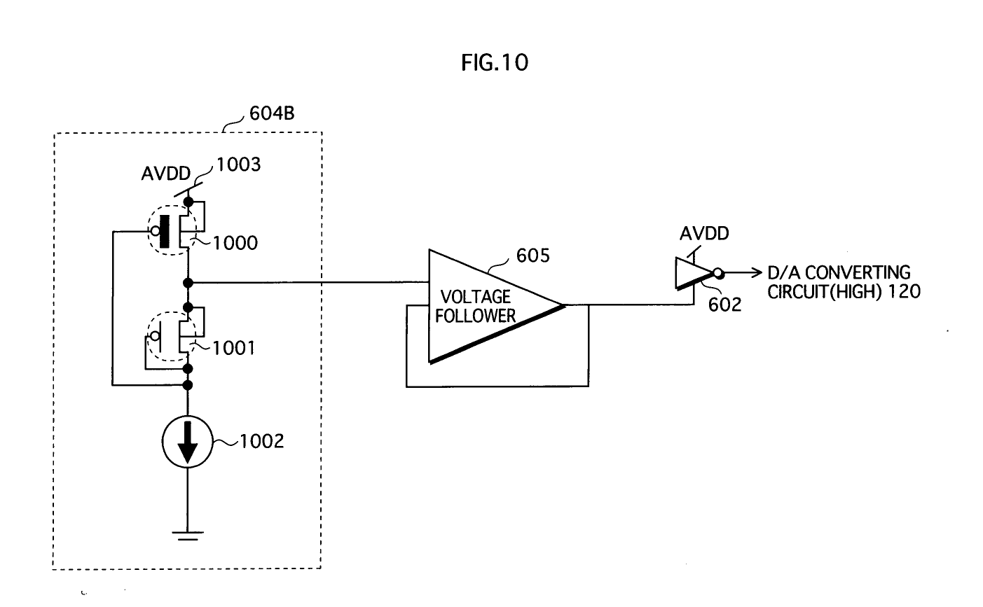

FIG. 10 shows the configuration of the amplitude determining circuit 604B according to the second configuration example.

The amplitude determining circuit 604B has another example of configuration that corresponds to the amplitude determining circuit 604 shown in FIG. 6.

The amplitude determining circuit 604B includes the parasitic transistor for measurement 1000 that has the p-channel-type property, the p-channel-type MOS transistor 1001, the current source 1002, and the power supply 1003. The current source 1002 is electrically connected with the gate electrode of the parasitic transistor for measurement 1000. The power supply 1003 with the AVDD voltage is electrically connected with the source electrode of the parasitic transistor for measurement 1000. The drain electrode of the parasitic transistor for measurement 1000 is electrically connected with the source electrode of the p-channel-type MOS transistor 1001 having a certain ON-state resistance value. It is arranged so that the potential between the source electrode of the P-channel-type MOS transistor 1001 and the drain electrode of the parasitic transistor for measurement 1000 is outputted to the voltage follower 605.

The current source 1002 supplies electric current at such a level that allows the parasitic transistor for measurement 1000 to be in an ON-state. Accordingly, the voltage supplied from the amplitude determining circuit 604B to the voltage follower 605 is higher than the gate voltage at such a level that allows the parasitic transistor for measurement 1000 to be in an ON-state by the ON-state resistance value of the p-channel-type MOS transistor 1001.

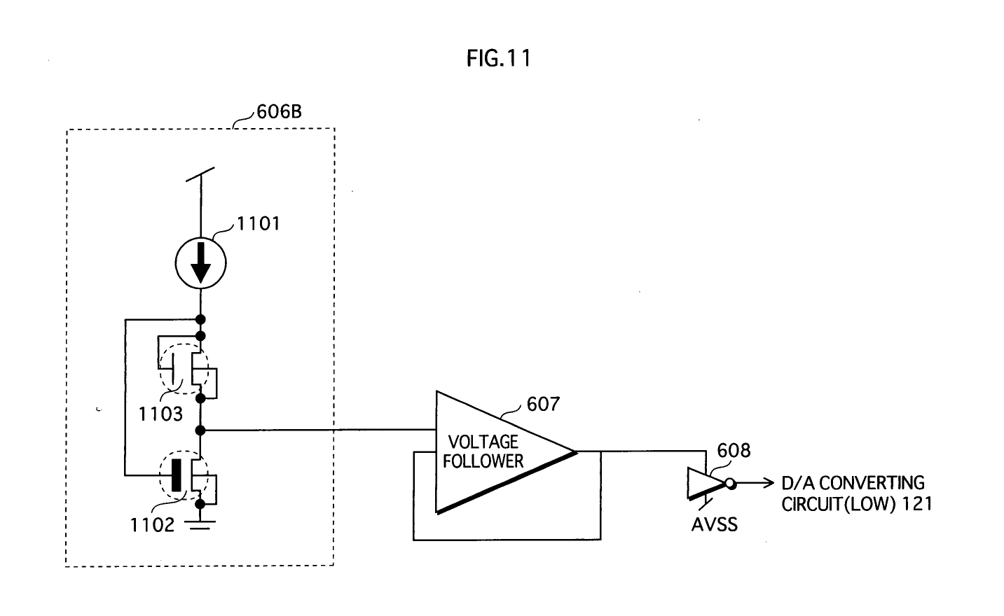

FIG. 11 shows the configuration of the amplitude determining circuit 606B according to the second configuration example.

The amplitude determining circuit 606B has another example of configuration that corresponds to the amplitude determining circuit 606 shown in FIG. 6.

The amplitude determining circuit 606B includes the current source 1101, the parasitic transistor for measurement 1102 having the n-channel-type property, and the n-channel-type MOS transistor 1103. The configuration is arranged as follows: The current source 1101 is electrically connected with the gate electrode of the parasitic transistor for measurement 1102. The drain electrode of the parasitic transistor for measurement 1102 is grounded. The source electrode of the parasitic transistor for measurement 1102 is electrically connected with the source electrode of the n-channel-type MOS transistor 1103 having a certain resistance value when it turns ON. The potential between the drain electrode of the n-channel-type MOS transistor 1103 and the source electrode of the parasitic transistor for measurement 1102 is outputted to the voltage follower 607.

The current source 1101 supplies electric current at such a level that allows the parasitic transistor for measurement 1102 to be in an ON-state. Accordingly, the voltage supplied from the amplitude determining circuit 606B to the voltage follower 607 is lower than the gate voltage at such a level that allows the parasitic transistor for measurement 1102 to be in an ON-state by the value of the certain resistance of the n-channel-type MOS transistor 1103 when it turns ON.

Third Configuration Example

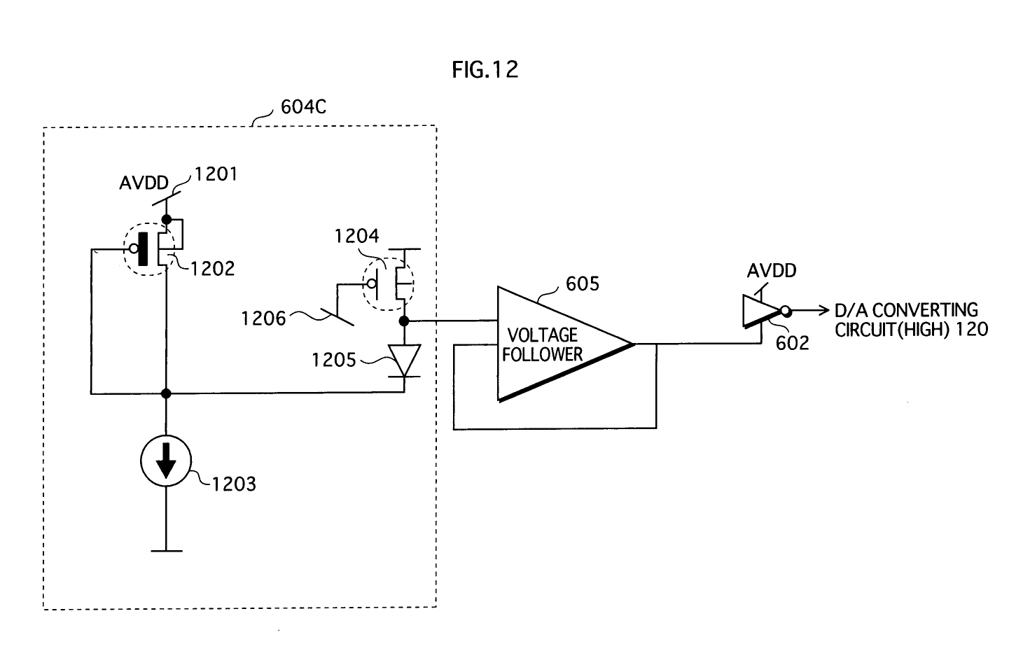

FIG. 12 shows the configuration of the amplitude determining circuit 604C according to the third configuration example.

The amplitude determining circuit 604C has another example of configuration that corresponds to the amplitude determining circuit 604 shown in FIG. 6.

The amplitude determining circuit 604C includes the power supply 1201, the parasitic transistor for measurement 1202, the current source 1203, and the p-channel-type MOS transistor 1204, the diode 1205, and the power supply 1206. The configuration is arranged as follows: The current source 1203 is electrically connected with the gate electrode and the drain electrode of the parasitic transistor for measurement 1202. The power supply 1201 is electrically connected with the source electrode of the parasitic transistor for measurement 1202. The gate electrode and the drain electrode of the parasitic transistor for measurement 1202 are electrically connected with the drain electrode of the p-channel-type MOS transistor 1204 via a diode 1205 having a certain resistance value.

The ON-state resistance value of the p-channel-type MOS transistor 1204 is arranged to be larger than the ON-state resistance value of the parasitic transistor for measurement 1202.

The source electrode of the p-channel-type MOS transistor 1204 is connected with a certain power supply. The gate electrode of the p-channel-type MOS transistor 1204 is connected with the power supply 1206 having a certain voltage. The p-channel-type MOS transistor 1204 is constantly kept in an ON-state.

The node between the drain electrode of p-channel-type MOS transistor 1204 and the input terminal of the diode 1205 is connected with the voltage follower 605.

The current source 1203 is arranged so as to supply electric current that allows the parasitic transistor for measurement 1202 to be in an ON-state. The voltage supplied to the voltage follower 605 is higher than the gate voltage that allows the parasitic transistor for measurement 1202 to be in an ON-state by the resistance value of the diode 1205.

It should be noted that the ON-state resistance of the transistor 1204 is arranged to be larger than the ON-state resistance of the parasitic transistor for measurement 1202. Consequently, the transistor 1204 becomes in conduction only if the voltage of the current source 1203 decreases and thereby the parasitic transistor for measurement 1202 does not come into an ON-state.

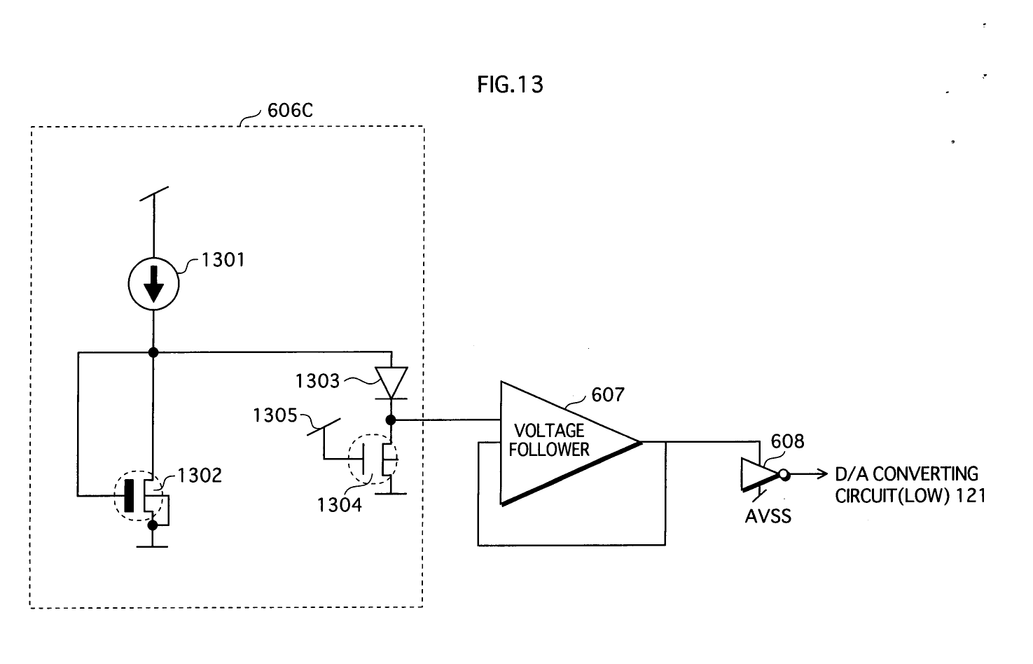

FIG. 13 shows the configuration of the amplitude determining circuit 606C according to the third configuration example.

The amplitude determining circuit 606C has another example of configuration that corresponds to the amplitude determining circuit 606 shown in FIG. 6.

The amplitude determining circuit 606C includes the current source 1301, the parasitic transistor for measurement 1302, the diode 1303, the n-channel-type MOS transistor 1304, and the power supply 1305. The configuration is arranged as follows: The current source 1301 is electrically connected with the gate electrode and the source electrode of the parasitic transistor for measurement 1302. The drain electrode of the parasitic transistor for measurement 1302 is grounded. The gate electrode and the source electrode of the parasitic transistor for measurement 1302 are electrically connected with the source electrode of the n-channel-type MOS transistor 1304 via a diode 1303 having a certain resistance value.

The ON-state resistance value of the n-channel-type MOS transistor 1304 is arranged to be larger than the ON-state resistance value of the parasitic transistor for measurement 1302.

The gate electrode of the n-channel-type MOS transistor 1304 is connected with a power supply 1305 having a certain voltage output. The n-channel-type MOS transistor 1304 is constantly kept in an ON-state.

The node between the source electrode of n-channel-type MOS transistor 1304 and the input terminal of the diode 1303 is connected with the voltage follower 607.

The current source 1302 is arranged so as to supply electric current that allows the parasitic transistor for measurement 1302 to be in an ON-state. The voltage supplied to the voltage follower 607 is higher than the gate voltage that allows the parasitic transistor for measurement 1302 to be in an ON-state by the resistance value of the diode 1303.

It should be noted that the ON-state resistance of the transistor 1304 is arranged to be larger than the ON-state resistance of the parasitic transistor for measurement 1302. Consequently, the transistor 1304 becomes in conduction only if the voltage of the current source 1301 decreases and thereby the parasitic transistor for measurement 1302 does not come into an ON-state.

The Fourth Configuration Example

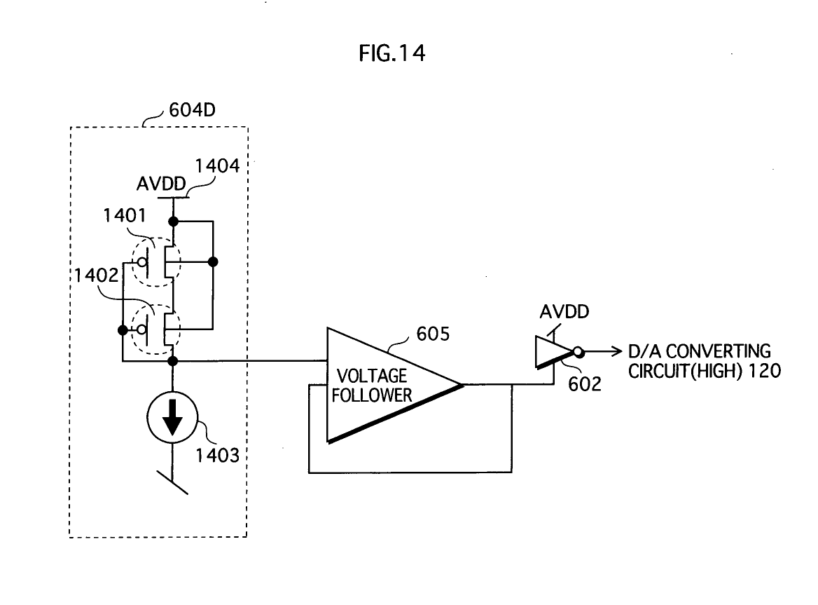

FIG. 14 shows the configuration of the amplitude determining circuit 604D according to the fourth configuration example.

The amplitude determining circuit 604D has another example of configuration that corresponds to the amplitude determining circuit 604 shown in FIG. 6.

The amplitude determining circuit 604D includes the p-channel-type MOS transistor 1401 and 1402 that each have the same size as each of the MOS transistors 300 to 305 included in the D/A converting circuit (High) 120 shown in FIG. 3; the current source 1403, and the power supply 1404. The source-drain paths of the p-channel-type MOS transistors 1401 and 1402 are connected in series. The gate electrodes of these MOS transistors are mutually connected in parallel. The gate electrodes, the current source 1403, and the voltage follower 605 are electrically connected. The drain electrode of the p-channel-type MOS transistor 1402 is connected with the current source 1403. The source electrode of the p-channel type MOS transistor 1401 is connected with the power supply 1404 that supplies AVDD.

The current source 1403 is arranged so as to supply a voltage at such a level that allows each of the p-channel-type MOS transistors 1401 and 1402 to be in an ON-state.

FIG. 14 shows an example in which the source-drain paths of the p-channel-type MOS transistors 1401 and 1402 are connected in series. The number of transistors to be connected is the same as the number of digits of the digital signal inputted to the D/A converting circuit (High) 120.

To the D/A converting circuit (High) 120, analogue voltage is outputted via the switches of as many p-channel-type MOS transistors as the number of digits of the digital signal to be inputted.

The amplitude determining circuit 604D generates a voltage at such a level that allows each of the p-channel-type MOS transistors 1401 and 1402 to be in an ON-state, the p-channel-type MOS transistors having their source-drain paths connected in series, and the amplitude determining circuit 604D outputs the generated voltage to the voltage follower 605. Consequently, the voltage of the digital signal outputted to the D/A converting circuit (High) 120 is able to prevent the parasitic transistors included in the D/A converting circuit (High) 120 from being switched on. Thus, the D/A converting circuit (High) 120 is able to function correctly.

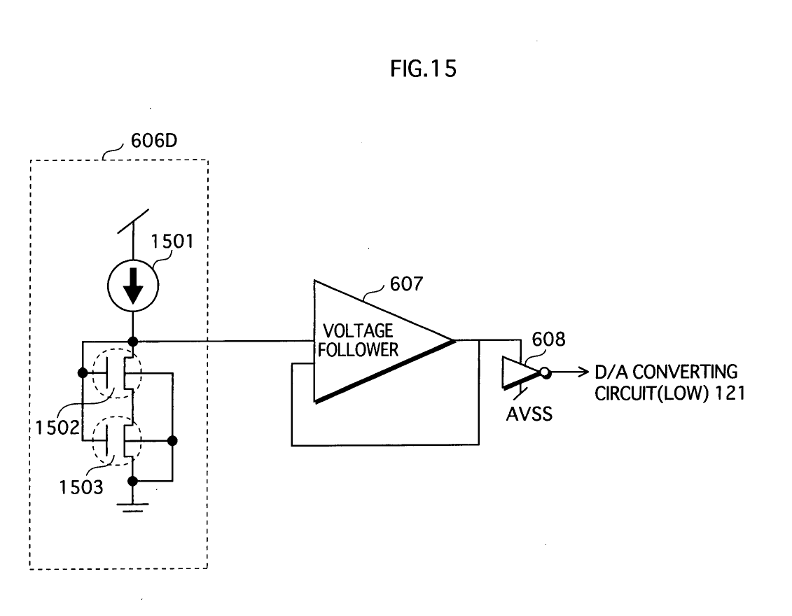

FIG. 15 shows the configuration of the amplitude determining circuit 606D according to the fourth configuration example.

The amplitude determining circuit 606D has another example of configuration that corresponds to the amplitude determining circuit 606 shown in FIG. 6.

The amplitude determining circuit 606D includes the n-channel-type MOS transistor 1502 and 1503 that each have the same size as each of the MOS transistors 200 to 205 included in the D/A converting circuit (Low) 121 shown in FIG. 2; and the current source 1501. The source-drain paths of the n-channel-type MOS transistors 1502 and 1503 are connected in series. The gate electrodes of these MOS transistors are mutually connected in parallel. The gate electrodes, the current source 1501, and the voltage follower 607 are electrically connected. The source electrode of the n-channel-type MOS transistor 1502 is connected with the current source 1501. The drain electrode of the n-channel type MOS transistor 1503 is grounded.

The current source 1501 is arranged so as to supply a voltage at such a level that allows each of the n-channel-type MOS transistors 1502 and 1503 to be in an ON-state.

FIG. 15 shows an example in which the source-drain paths of the n-channel-type MOS transistors 1502 and 1503 are connected in series. The number of transistors to be connected is the same as the number of digits of the digital signal inputted to the D/A converting circuit (Low) 121.

To the D/A converting circuit (Low) 121, analogue voltage is outputted via the switches of as many n-channel-type MOS transistors as the number of digits of the digital signal to be inputted.

The amplitude determining circuit 606D generates a voltage at the smallest possible level that allows each of the n-channel-type MOS transistors 1502 and 1503 to be in an ON-state, the n-channel-type MOS transistors having their source-drain path connected in series, and the amplitude determining circuit 1500 outputs the generated voltage to the voltage follower 607. Consequently, the voltage of the digital signal outputted to the D/A converting circuit (Low) 121 is able to prevent the parasitic transistors included in the D/A converting circuit (Low) 121 from being switched on. Thus, the D/A converting circuit (Low) 121 is able to function correctly.

Supplementary Information

The present invention is not limited to what has been described in the above embodiments. The following examples are also included in the present invention.

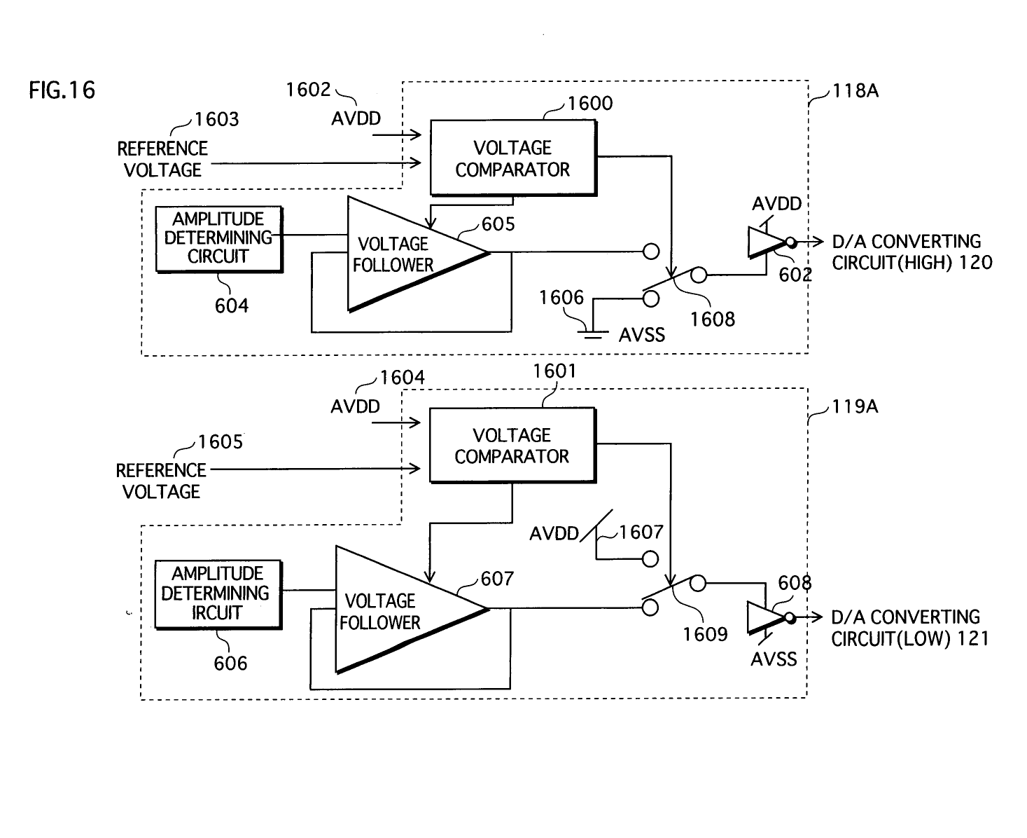

(1) FIG. 16 shows the configuration of the regulator circuits 118A and 119A in which the voltage comparators 1600 and 1601, and the switches 1608 and 1609 are added to the regulator circuits 118 and 119 described in the above embodiment.

The voltage comparator 1600 compares AVDD 1602 with the reference voltage 1603 which is a voltage at such a level that no parasitic transistors in the D/A converting circuit (High) 120 are switched on. As a result of the comparison, when AVDD 1602 is lower than the reference voltage 1603, the voltage comparator 1600 stops the power supply to the voltage follower 605 in order to save the electricity and controls the switch 1608 so that AVSS 1606 is outputted to the D/A converting circuit (High) 120.

Conversely, when AVDD 1602 is higher than the reference voltage 1603 the voltage comparator 1600 supplies electric power to the voltage follower 605, and controls the switch 1608 so that the voltage outputted from the voltage follower 605 is outputted to the D/A converting circuit (High) 120.

The voltage comparator 1601 compares the power supply voltage of the liquid crystal driving circuit (AVDD) 1604 with the reference voltage 1605 which is a voltage at such a level that no parasitic transistors in the D/A converting circuit (Low) 121 are switched on. As a result of the comparison, when AVDD 1604 is lower than the reference voltage 1605, the voltage comparator 1601 stops the power supply to the voltage follower 607 in order to save the electricity and controls the switch 1609 so that AVDD 1607 is outputted to the D/A converting circuit (Low) 121.

Conversely, when AVDD 1604 is higher than the reference voltage 1605, the voltage comparator 1601 supplies electric power to the voltage follower 607, and controls the switch 1609 so that the voltage outputted from the voltage follower 607 is outputted to the D/A converting circuit (Low) 121.

(2) In the second configuration example above, it is acceptable to use a resistor or a diode having a certain resistance value, instead of the transistors 1001 and 1103. In the third configuration example above, it is acceptable to use a resistor having a certain resistance value, or a transistor having a certain resistance value when it turns ON, instead of the diodes 1205 and 1303.

(3) In the fourth configuration example above, there is an arrangement in which the number of the MOS transistors included in each of the amplitude determining circuits 604D and 606D is the same as the number of digits in the digital signal inputted to each of the D/A converting circuit (High) 120 and the D/A converting circuit (Low) 121; however, it is acceptable that the number of the MOS transistors is larger than the number of the digits of the digital signal to be inputted to each of the D/A converting circuits.

(4) In the above embodiment, it is described that the electrodes of the MOS transistors and the gate electrode of the parasitic transistors are made of polysilicon; however, the present invention is not limited to this example. It is acceptable, for example, that a gate electrode has a Salicide structure.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A liquid crystal driving circuit comprising:
a converting circuit that (i) includes MOS transistors corresponding to an inputted signal, wherein gate electrodes of at least two of the MOS transistors are electrically connected with each other with a wiring made of a same material as the gate electrodes, and a parasitic transistor is formed between said at least two MOS transistors, and (ii) is operable to select one of a plurality of reference voltages as a result of switching operations of the MOS transistors, the selection being made in response to the inputted signal, and to output the selected reference voltage as a voltage to be applied to a liquid crystal display element; and
a regulator circuit operable to regulate a signal so as to have a specific amplitude being smaller than an amplitude of a signal which makes the parasitic transistor change to an ON-state and to output the regulated signal having the specific amplitude as the inputted signal to the converting circuit.

2. The liquid crystal driving circuit of claim 1, wherein
said at least two MOS transistors are positioned adjacent to each other and perform a switching operation concurrently with each other in response to a change of the inputted signal.

3. The liquid crystal driving circuit of claim 1, wherein
the converting circuit includes a plurality of parasitic transistors, and
the regulated signal has the specific amplitude being smaller than an amplitude of a signal which makes at least one of the parasitic transistors switch on.

4. The liquid crystal driving circuit of claim 1, wherein
the converting circuit includes:
a first converting circuit including a plurality of n-channel-type transistors and being operable to output a first reference voltage in response to a first inputted signal; and
a second converting circuit including a plurality of p-channel-type transistors and being operable to output a second reference voltage that is higher than the first reference voltage, in response to a second inputted signal, and
the regulator circuit includes:
a first regulator circuit operable to regulate a signal so as to have a first specific amplitude being smaller than an amplitude of a signal which makes a parasitic transistor formed in the first converting circuit switch on and to output the regulated signal as the first inputted signal; and
a second regulator circuit operable to regulate a signal so as to have a second specific amplitude being smaller than an amplitude of a signal which makes a parasitic transistor formed in the second converting circuit switch on and to output the regulated signal as the second inputted signal.

5. The liquid crystal driving circuit of claim 4, wherein
the regulator circuit further includes:
a voltage generating circuit operable to generate a first voltage and a second voltage, and
the first regulator circuit outputs the regulated signal having the first specific amplitude in response to a difference between the first voltage generated by the voltage generating circuit and a voltage of a first power supply, and the second regulator circuit outputs the regulated signal having the second specific amplitude in response to a difference between the second voltage generated by the voltage generating circuit and a voltage of a second power supply being different from the first power supply.

6. The liquid crystal driving circuit of claim 1, wherein
the regulator circuit includes:
an amplitude determining circuit operable to output a voltage;
a voltage follower coupled to the amplitude determining circuit and operable to stabilize the voltage; and
an output buffer operable to output the regulated signal having the specific amplitude to the converting circuit in response to a difference between the stabilized voltage generated by the voltage follower and a voltage of a power supply.

7. The liquid crystal driving circuit of claim 6, wherein
the amplitude determining circuit includes:
a plurality of parasitic transistors for measurement; and
a selecting circuit operable to apply voltages each having a different level from one another to gates of the plurality of parasitic transistors for measurement respectively and select one of the voltages in response to a switching operation of the plurality of parasitic transistors for measurement.

8. The liquid crystal driving circuit of claim 6, wherein
the amplitude determining circuit includes:
a parasitic transistor for measurement coupled to the power supply; and
a current source coupled to another power supply being different from the power supply and a gate of the parasitic transistor for measurement, and
a certain load is configured on a path between either a drain or a source of the parasitic transistor for measurement and the current source, the certain load being coupled to the gate and either the drain or the source of the parasitic transistor for measurement, and
either the drain or the source of the parasitic transistor for measurement is coupled to an input terminal of the voltage follower.

9. The liquid crystal driving circuit of claim 6, wherein
the amplitude determining circuit includes:
a parasitic transistor for measurement coupled to the power supply;
a current source coupled to another power supply being different from the power supply, to a gate, and to either a drain or a source of the parasitic transistor for measurement;
a diode coupled to the gate, to either the drain or the source of the parasitic transistor for measurement, and to the current source; and
a MOS transistor coupled to the diode, the MOS transistor constantly being kept in an ON-state, in such a manner that a connection node between the MOS transistor and the diode is coupled to an input terminal of the voltage follower,
wherein an ON-state resistance of the MOS transistor is larger than an ON-state resistance of the parasitic transistor for measurement.

10. The liquid crystal driving circuit of claim 6, wherein
the amplitude determining circuit includes:
a plurality of MOS transistors for measurement whose source-drain paths being electrically connected in series, one end of the serially-connected plurality of MOS transistors for measurement being coupled to the power supply, gate electrodes of the plurality of MOS transistors for measurement being electrically connected with one another, each of the plurality of MOS transistors for measurement being equal in size to each of MOS transistors in the converting circuit respectively, a number of the plurality of MOS transistors for measurement being equal to or larger than a number of MOS transistors to select the selected reference voltage in the converting circuit; and
a current source being configured between another end of the serially-connected plurality of MOS transistors for measurement and another power supply being different from the power supply,
wherein a connection node of said another end of the serially-connected plurality of MOS transistors for measurement and the current source is connected to an input terminal of the voltage follower.

11. The liquid crystal driving circuit of claim 6, wherein
the regulator circuit further includes:
a switch circuit operable to selectively switch between (i) a first connection provided between the voltage follower and the output buffer and (ii) a second connection provided between a first power supply and the output buffer; and
a comparator circuit operable to compare a voltage of a second power supply with the selected reference voltage and, according to a result of the comparison, instruct the switching circuit to switch connections so as to have one of the first and second connections,
wherein a supply of electric power to the voltage follower is stopped in a case where the switching circuit switches the connections so as to have the second connection.
